(19) United States
(12) Patent Application Publication
(10) Pub. No.: US 2006/0130728 A1
(43) Pub. Date: Jun. 22, 2006

(54) Mooring system for offshore fish production

(76) Inventors: Noam Zeichner, Kfar Hess (IL); Omri Ben-Eliahu, Bney Dror 95 (IL)

Correspondence Address: VARNUM, RIDDERING, SCHMIDT & HOWLETT LLP, 333 BRIDGE STREET, NW, P.O. BOX 352, GRAND RAPIDS, MI, 49501-0352, US

(21) Appl. No.: 10/543,847

(22) PCT Filed: Nov. 10, 2003
(86) PCT No.: PCT/IL03/00935

§ 371 Date: Jul. 29, 2005

(30) Foreign Application Priority Data
Nov. 10, 2002 (IL) 152722

(51) Int. Cl. B63B 21/00

(52) U.S. Cl. 114/230.1

(57) ABSTRACT

A flexible fish cage system for open sea aquaculture using a mono-buoy plus special frame design to absorb the wave energy. The system includes a flexible construction holding the fish nets. The system is submersible by an air pumping mechanism which displaces water out of water fillable tanks.

### CROSS-REFERENCE TO RELATED APPLICATIONS

This is a non-provisional national stage application that claims the benefit of PCT application PCT/IL2003/00095 of the same title and published on 27 May 2004 as publication WO 2004/043777, the disclosure of which is incorporated here by reference.

### BACKGROUND OF THE INVENTION

The present invention relates to offshore marine-culture. More specifically the invention relates to submergible and flexible fish-cage technology designed to solve the key needs of marine-culture on open seas.

Typically, waves apply the prominent environmental load onto offshore installations. Ocean waves are observed as lateral waves that propagate over the free surface—the surface that separates the water from the atmosphere. However, aside from changing the water surface elevation, waves also induce orbital currents and accelerate water particles deep below the free surface. The diameter of the circular motion of particles in the sea surface is equal to the wave height—vertical height between wave trough and wave crest. The orbit diameter decreases farther down the deeper water, and at a depth of about half a wavelength, motion is almost completely vanished.

The parameters of an extreme wave, with an average return period of about 50 years, in the Mediterranean Sea at the shores of Israel, are as follows:
Significant wave height (average height of the one-third highest waves in a sample)—about 8 meters (26.2 ft).
Maximum single wave height—about 16 meters (52.5 ft).
Peak period, namely the wave period at which the wave spectrum (a function describes the energy-frequency distribution) has a maximum—about 16 seconds.
Wavelength corresponding to peak period—about 400 meters (1,312.3 ft).

Typically, the orbital velocity induced by waves is significantly greater than the speed of currents. However, currents are an important factor in the determination of anchoring load applied by cages because of their slow variation in time relative to the fast variation of wave-induced velocities. Flexible anchoring (long ropes) allows decreasing wave influence on anchoring loads since the water displacements induced by waves are limited. Loads applied by currents are not dependent upon the rigidity of anchoring, hence must be reacted by the anchoring system.

The current force exerted on sea structures is a drag force that can be assessed through empirical equations. In general the drag force is proportional to the seawater density, to the current speed squared, and to the area of the cross-section of the element, perpendicular to the flow. The ratio of the drag force to the product of these three parameters is defined as a drag coefficient. The drag coefficient is geometrically dependent on the body, and is usually found in experiments. More precisely, the drag coefficient is also weakly dependent upon speed, so the force is not exactly proportional to the squared speed of the current.

Velocity of water in waves is not constant speed and the water particles accelerate and decelerate. In addition to drag force related to speed, an inertial force will also act upon a submerged body in waves. For bodies that are small in relation to wavelength, one can assess the inertial forces by a simple engineering formula, wherein the inertia force is proportional to the acceleration of water particles to the seawater density, and to the immersed volume. The ratio of the inertia force to the product of these three parameters is defined as the inertia coefficient, which is dependent upon the geometric shape of the body. The inertia coefficient may be interpreted as the mass of water whose acceleration was prevented due to the presence of a body, and is also termed hydrodynamic mass. Wave force applied to small bodies relative to wavelength can be estimated by superposition of drag and inertia forces on the elements that comprise the structure.

Cages for growing fish are known in the art. They are typically placed in calm fiords or bays that present no extreme sea conditions, hazardous to the cages and facilitate convenient maintenance. As the fiord is contaminated by the fish cages and industrial pollution the cages can be moved to a less contaminated site in the bay or fiord. Thus, cage builders developed cages for near-shore locations and calm waters. Most cages are built to resist wave energy up to specific level, most of these systems are multiple mooring systems.

There are attempts, conducted in various countries, such as the USA and European countries to introduce diving systems that can operate in 35-meter sea depth (114.8 ft), to avoid mechanical stress of a heavy sea. When a storm occurs, pulleys are used to lift or submerge the cages. These systems are sensitive and fail where maintenance is insufficient. In such known systems, each cage has its own mooring system.

In case of short storm notice or technical problem with one of the many pulleys the system fails. It is impossible to operate the pulleys in rough sea conditions.

The need to operate open sea caging systems led to cages constructed as boats or huge rigid floats. These systems fight the sea effectively but the cage nets fold by the storm and the fish choke to death.

Other designs tend to build floating systems with rigid frames these are very complex, expensive to purchase and operate and dangerous to operate since the divers enter the cages below sea level.

Several aspects are to be considered when planning to grow fish in offshore cages:
Biological aspect—The aim of the cages is to offer a suitable environment for growing fish and with this in mind the cages must be properly designed.
Environmental aspect—To preserve the natural environment; any negative impact the farm may present, must be minimized.
Operational and economic aspect—Operation must be simplified; set up and operation costs curbed so that the farm will be profitable.
Mechanical aspect—Safe anchoring and structural integrity of an offshore cage system must be ensured along with biological and operational cost effective considerations.

Current forces acting upon nets is discussed in: “Current Forces on Cage and Net Deflection”, by Jan V. Aarsen, Geir LΦland, and Harard Rudi, MARINTEK, Norway, Engineering of Offshore Fish Farming, Glasgow, October 1990. The article presents an algorithm for estimating current forces, by means of empirical formulas fitted to the results of hydraulic laboratory experiments with models of net panels.

For the structure to withstand adverse sea conditions and yet maintain minimal costs it is preferable to kinetically comply with the surrounding sea rather than try to oppose it. Flexible cages are energy observers while rigid cages are simpler to dive. As much as the cage can observe more energy and be simpler to dive, it will be the preferred cage.

### BRIEF SUMMARY OF THE INVENTION

Accordingly, the invention addresses shortcomings of prior moored fish production systems. An offshore fish production mooring system of the invention has least two fish cages tensioned by flexible ballasts that are flexibly and serially connected to a front frame and has a mooring rope that connects the front frame to an anchor. The mooring system further has at least one float connected to the anchor for marking the system, as well as a rope tension moderating buoy that is connected to the rope and that moderates rope tension. At least one set of ropes that connect the fish cages among themselves and to the front frame is also included. At least one ocean water fillable construction element is provided and adapted for air to be pumped into the element and push out the water. At least one valve is also provided to allow sea water in and out of the ocean water fillable construction element.

In one aspect of the invention, the water fillable construction element may include at least one longitudinal pipe. In another aspect of the invention, the flexible ballasts may be chain connected at least with the two fish cages. In yet a further aspect of the invention, the lumens of the water fillable construction elements are interconnected so as to allow direct passage through the respective lumens.

The present invention also provides a method for refloating a system of fish cages submerged in the open sea process that includes the steps of connecting an air source to at least one ocean water fillable construction element; pumping air into said at least one fillable construction element until the secondary floats surface; waiting until the fish have decompressed, and further pumping air into construction elements until cages have reached the operational depth.

The present invention further provides a method for balancing a system of fish cages in which each fish cage including its ballasts, has a substantially neutral buoyancy and is stabilized by a weight associated with a construction element.

These and other features, objectives, and benefits of the invention will be recognized by one having ordinary skill in the art and by those who practice the invention, from this disclosure, including the specification, the claims, and the drawing figures.

### BRIEF DESCRIPTION OF THE SEVERAL VIEWS OF THE DRAWING

FIG. 1 is a schematic isometric view of a fish cage system of the invention, indicating some features;

FIG. 2A is a schematic top view describing stabilizing elements of the fish cage system of the invention;

FIG. 2A is another schematic top view describing stabilizing elements of the fish cage system of the invention;

FIG. 3 is a schematic isometric view of the fish cage system of the invention showing the rope system;

FIG. 4 is a schematic side view description of the operating and submersion positions of a system of the invention;

FIG. 5A is a schematic view of a submerged fish cage to which an indicating buoy has been connected;

FIG. 5B is the view of FIG. 5A with the fish cage refloated and showing the surfacing of a secondary float.

### DETAILED DESCRIPTION

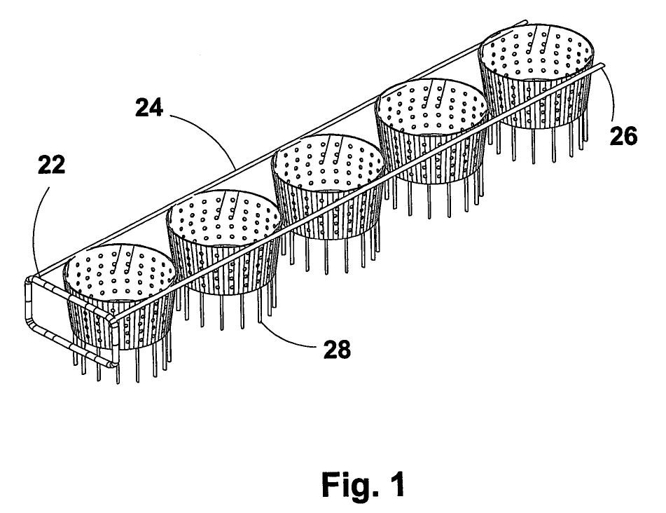

In accordance with the present invention, a cage system for fish culture is provided. In the following description the term fish relates to all kinds of sea dwelling animals such as fish, sea food, crustaceans used as food. The system of the invention is a single point mooring device in which fish cages, typically 2-5 are arranged serially, fastened to a flexible structure well fitted for absorbing heavy sea energy. The system is connected to an anchor via flexible mooring rope, and a rope tension moderating buoy, allowing free movement in the water, as limited by the length of the rope and other physical obstacles. In FIG. 1, to which reference is now made, some features of the system are shown. A front frame 22 is a metal construction, preferably a hollow tube, connects to two longitudinal pipes 24 and 26. These pipes are made of flexible plastic material, typically polyethylene. In a preferred embodiment of the invention, the lumen of the front frame and the longitudinal pipes is connected to allow free passage of air or fluid. Five fish-cages in the form of closed fish cages are enclosed within the front frame and the longitudinal pipes 24 and 26. A plurality of ballasts, such as ballast 28, hang down from the fish cages.

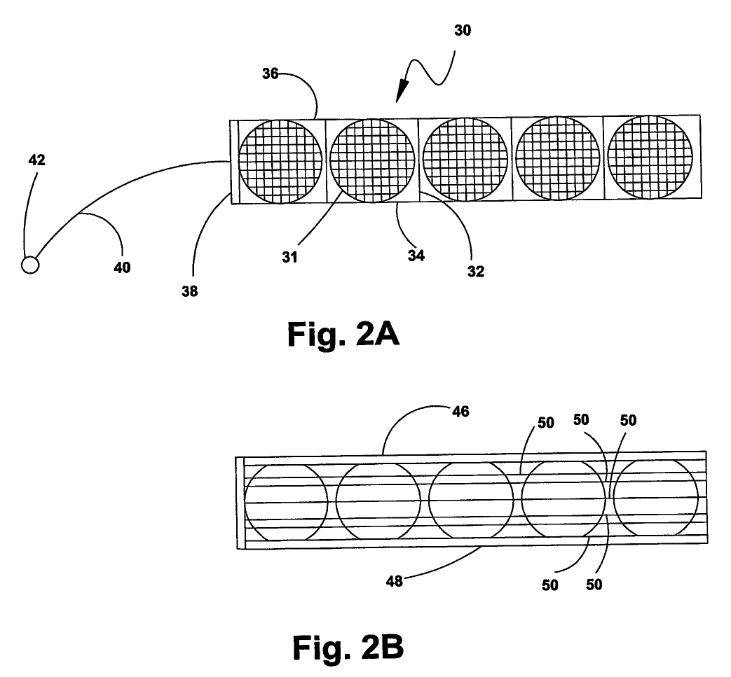

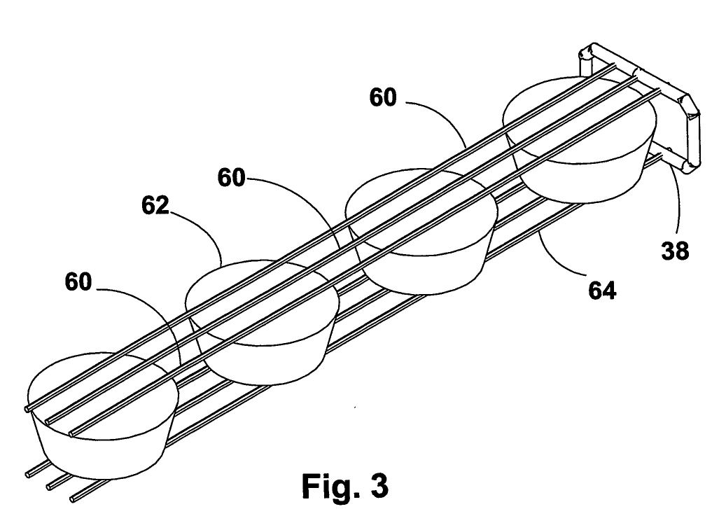

Further details of variations of the system are shown in reference to FIGS. 2A and 3B. In top-side view 2A, the system 30 holds five fish cages such as fish cage 31, which are separated by an optional constructional element 32 which hold the two ropes 34 and 36 apart. The front frame 38 is tied via a mooring rope 40 to a rope tension moderating buoy 42. In FIG. 2B another variety of the system is shown, in which longitudinal pipes 46 and 48 are disposed, the functionality of which will be explained later, and in addition longitudinal ropes 50 are connected to the fish cage hangers (not shown) for holding the fish cages together and in connection to the front frame. In FIG. 3 to which reference is now made, longitudinal ropes 60 are disposed at the top side of the fish cage 62, and a second set of ropes 64 is disposed at the bottom side of the fish cages. Each rope set is tied to the front frame 38 and to the fish growing cages. In this drawing, the longitudinal pipes are not drawn. The term rope in this respect is a generalized term meaning any flexible connecting chord such as made from fibers, metal fibers, plastic fibers, or chains, for example.

Submergence and Reflotation

The fish cage system of the invention is relatively stable owing to mechanical features. Each fish cage, including its ballasts is substantially neutral with respect to its own buoyancy. And the whole system is stabilized by a weight associated with the front frame. The fish cage system of the invention includes several sets of hanging ballasts. A first set are the ballast hanging from the fish cages. These ballasts are flexible preferably constructed of metal chains hanging from the nets. Another set of hanging ballasts hang from the front frame, and another optional set hang from the longitudinal pipes downwards. The system of fish cages are submerged to a depth of few tens of meters (32.8 ft per 10 m), in preparation for a storm. The mechanical energy absorbed by the system is substantially smaller at such depths than at the sea surface. To submerge the cage system, water is made to fill some elements of the system. The front frame, being a tube, has a valve to allow sea water in and out. The longitudinal pipes if present are also made to be filled with water. When these constructions are filled with water, the cage system can sink. The dimensions of these constructions, and the material from which they are constructed, must be calculated to permit the submergence of the system upon filling of the constructions with water.

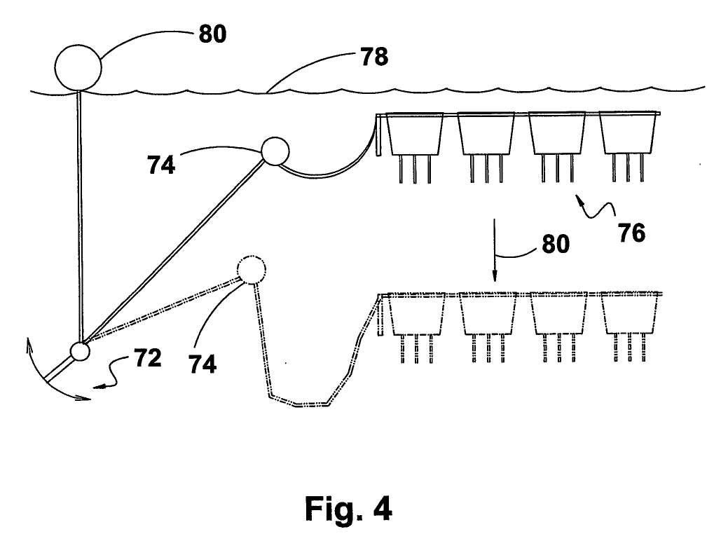

In FIG. 4 two different buoys are described in a side view of the system. Float 70 is connected directly to anchor 72 to mark the system generally. Rope tension moderating buoy 74 connects to the cage system through a rope, which is tied to the front frame. At position 76 the cage system is close to the sea surface 78. As it is lowered in the direction of arrow 80, the system drawn in phantom lines, can reach the bottom such that floats at the bottom of the net may fold (not shown). Buoy 74 is typically lowered substantially at this position too.

In preparation for sinking the system of cages to the depth, additional buoys are connected to each cage, to mark its place from above.

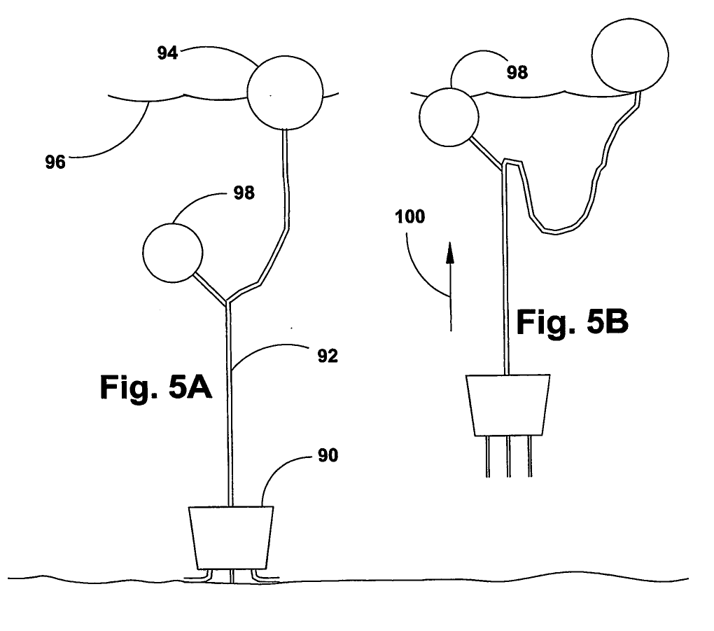

When refloating the cages, hoses are connected to valves in the construction elements containing water, typically the front frame and the longitudinal pipes, and air is pumped in, pushing water out of theses elements. In a preferred embodiment of the invention, long hoses are connected to the appropriate opening in the relevant construction elements, prior to the submergence, and each loose end designated by a buoy, they can be found easily to be connected to the air source. Pumping air causes a gradual increase in air in the system which facilitates a careful uplifting of the cages, and safe repositioning in the normal operating zone. Since the cages of the system of the invention are prone to be submerged in depth, some fish types may need to be accommodated to the change in water pressure on the way up. To assist in this process, extra floats are provided as described in FIGS. 5A and 5B to which reference is now made. In these figures only one fish cage is shown for the sake of simplicity. The submerged system is shown in FIG. 5A showing the fish cage 90. Rope 92 connects to the fish cage designating float 94 floating at or near the sea surface 96 and to a lifting float 98. In FIG. 5B the cage has risen in the direction of arrow 100, so that secondary float 98 appears on the surface. At this stage the lifting is stopped until the decompression stage is over and the cages can be lifted to the final position, typically by pumping air into the longitudinal pipes.

Uses of the System of the Invention

The Cage system of the invention can withstand substantially adverse open sea conditions. The system of the invention is operational in sea water in which water depth is 35-80 meter (114.8-262.5 ft) (or more). It is resistant and can take storms of rough sea as it can be conveniently submerged to escape from the storm. When the system is submerged, all that is left to be seen on the sea surface is small floats or a few buoys, that designate the location of the system when sea is calm again. Mooring circle of each system to the neighboring system is calculated in the same manners as boat mooring.

One having ordinary skill in the art and those who practice the invention will understand from this disclosure that various modifications and improvements may be made without departing from the spirit of the disclosed inventive concept. One will also understand that various relational terms, including left, right, front, back, top, and bottom, for example, are used in the detailed description of the invention and in the claims only to convey relative positioning of various elements of the claimed invention.

What is claimed is:

1. A system for growing fish in the open sea wherein at least two fish cages tensioned by flexible ballasts are flexibly serially connected to a front frame, comprising:
a mooring rope for connecting said front frame to an anchor;
a rope tension moderating buoy connected to said rope for moderating its tension;
at least one set of ropes for connecting said fish cages among themselves and to said front frame;
at least one float connected to said anchor for marking the system;
at least one ocean-water fillable construction element wherein air can be pumped in for pushing said water out;
at least one valve for allowing sea water in and out of said at least one ocean water fillable construction element, and
flexible ballasts.

2. A system for growing fish in the open sea as in claim 1 wherein at least one longitudinal pipe is used as water fillable construction element.

3. A system for growing fish in the open sea as in claim 1 and wherein said flexible ballasts are made of metal chain and are connected to at least said two fish cages, respectively.

4. A system for growing fish in the open sea as in claim 1 and wherein the lumens of all said water fillable construction elements are inter-connected allowing direct passage through said respective lumens.

5. A method for refloating a system of fish cages submerged in the open sea, comprising the steps of:
connecting an air source to at least one ocean water fillable construction element;
pumping air into said at least one fillable construction element until the secondary floats surface;
waiting until the fish have decompressed, and
further pumping air into construction elements until cages have reached the operational depth

6. A method for balancing a system of fish cages in which each fish cage, including its ballasts has a substantially neutral buoyancy, and is stabilized by a weight associated with a construction element.
